(19) United States
(12) Patent Application Publication
(10) Pub. No.: US 2020/0201436 A1
(43) Pub. Date: Jun. 25, 2020

(54) METHOD AND DEVICE FOR PROVIDING HAPTIC FEEDBACK IN VIRTUAL REALITY SYSTEM

(71) Applicant: BOE TECHNOLOGY GROUP CO., LTD., Beining (CN)

(72) Inventors: Yanling HAN, Beijing (CN); Xue DONG, Beijing (CN); Jing LV, Beijing (CN); Haisheng WANG, Beijing (CN); Chun Wei WU, Beijing (CN); Xiaoliang DING, Beijing (CN); Wei LIU, Beijing (CN); Pengpeng WANG, Beijing (CN); Xueyou CAO, Beijing (CN); Ping ZHANG, Beijing (CN)

(73) Assignee: BOE Technology Group Co., Ltd., Beijing (CN)

(21) Appl. No.: 15/751,211

(22) PCT Filed: Aug. 9, 2017
(86) PCT No.: PCT/CN17/96617

§ 371 Date: Feb. 8, 2018

(30) Foreign Application Priority Data
Jan. 3, 2017 (CN) 201710002398.6

(51) Int. Cl. G06F 3/01; G06F 3/044

(52) U.S. Cl. CPC G06F 3/016; G06F 3/044

(57) ABSTRACT

Embodiments of the present disclosure provide a method and a device for providing haptic feedback in a virtual reality system. The method includes acquiring state information of one or more virtual objects in a virtual scene presented in the virtual reality system and/or one or more real objects in an external environment of a user using the virtual reality system; generating haptic feedback information according to the state information; and providing haptic feedback to the user according to the haptic feedback information.

### CROSS-REFERENCE TO RELATED APPLICATIONS

This application claims priority to Chinese Patent Application No. 201710002398.6, filed on Jan. 3, 2017, the entire contents thereof are incorporated herein by reference.

### TECHNICAL FIELD

The present disclosure relates to, but not limited to virtual reality technology, and more particularly to a method and a device for providing haptic feedback in a virtual reality system.

### BACKGROUND

Virtual reality technology is a kind of computer simulation system that can create and allow experiencing a virtual world. It can generate a simulation environment with a computer. Through system simulation of interactive 3D dynamic scene and entity behavior based on multi-source information fusion, user may be immersed in the environment.

At present, take a helmet-based virtual reality as an example, it is implemented mainly by completely filling a viewers' visual field with a displayed scene through the computer simulation system. The user may obtain a good sense of immersion through the computer-generated simulation environment.

At present, the virtual reality technology mainly enables the user to gain a sense of immersion in the visual display, and the user gets a monotonous virtual reality experience. In addition, when the user wears a virtual display device, he or she can not accurately know about the location of people and objects in the environment which the user is located in. Therefore, the user's activities are generally limited to a certain range (either sitting or standing). Then, the user cannot be completely immerged in the virtual reality scene due to the limited activity range. If the user is completely immerged in the virtual reality scene, the user may involuntarily perform physical activity, which tends to collide with people and objects in the environment which the user is located in, causing human body collision or object damage and affecting the user experience.

### SUMMARY

Embodiments of the present disclosure provide a method and a device for providing haptic feedback in a virtual reality system, which can enhance user experience of virtual reality.

According to an aspect of an embodiment of the present disclosure, there is provided a method for providing haptic feedback in a virtual reality system. In the method, it is acquired state information of one or more virtual objects in a virtual scene presented in the virtual reality system and/or one or more real objects in an external environment of a user using the virtual reality system. Haptic feedback information is generated according to the state information. Haptic feedback is provided to the user according to the haptic feedback information.

In an embodiment of the present disclosure, acquiring state information of one or more real objects in an external environment of a user using the virtual reality system, includes: detecting movement state information of the one or more real objects in the external environment. The movement state information includes at least one of position, moving direction, and moving speed.

In an embodiment of the present disclosure, generating haptic feedback information according to the state information includes: determining a distance between the user and the one or more real objects according to the movement state information of the one or more real objects; and generating distance-based feedback intensity information corresponding to the one or more real objects respectively as the haptic feedback information.

In an embodiment of the present disclosure, providing haptic feedback to the user according to the haptic feedback information includes: providing pressure corresponding to the feedback intensity information to the user; and/or providing vibration corresponding to the feedback intensity information to the user.

In an embodiment of the present disclosure, acquiring state information of one or more virtual objects in a virtual scene presented in the virtual reality system includes: recognizing the one or more virtual objects in the virtual scene; and determining physical state information respectively corresponding to the one or more virtual objects. The physical state information includes hardness and/or roughness.

In an embodiment of the present disclosure, generating haptic feedback information according to the state information includes: generating touch perception information respectively corresponding to the one or more virtual objects according to the physical state information of the one or more virtual objects, as the haptic feedback information. The touch perception information includes a size of a force required for perceiving hardness and/or roughness of an object.

In an embodiment of the present disclosure, providing haptic feedback to the user according to the haptic feedback information includes: according to a touch position of the user on a touch screen displaying an image of the virtual scene, determining a touched virtual object in the image; supplying a voltage signal to the touch screen based on the touch perception information of the touched virtual object; and generating an induction capacitance and an electrostatic force at the touch position based on the voltage signal.

In an embodiment of the present disclosure, providing haptic feedback to the user according to the haptic feedback information further includes: detecting a touch pressure of the user. In response to the touch pressure being greater than a preset threshold, supplying a voltage signal to the touch screen.

According to an aspect of an embodiment of the present disclosure, there is provided a device for providing haptic feedback in a virtual reality system, including: one or more processors; a memory coupled to the processor and storing computer program instructions, wherein the computer program instructions, when executed by the processor, cause the device to: acquire state information of one or more virtual objects in a virtual scene presented in the virtual reality system and/or one or more real objects in an external environment of a user using the virtual reality system; generate haptic feedback information according to the state information; and provide haptic feedback to the user according to the haptic feedback information.

In an embodiment of the present disclosure, the computer program instructions, when executed by the processor, cause the device to: detect movement state information of the one or more real objects in the external environment. The movement state information includes at least one of position, moving direction, and moving speed.

In an embodiment of the present disclosure, the computer program instructions, when executed by the processor, cause the device to: determine a distance between the user and the one or more real objects according to the movement state information of the one or more real objects; and generate distance-based feedback intensity information corresponding to the one or more real objects respectively as the haptic feedback information.

In an embodiment of the present disclosure, the computer program instructions, when executed by the processor, cause the device to: provide pressure corresponding to the feedback intensity information to the user; and/or provide vibration corresponding to the feedback intensity information to the user.

In an embodiment of the present disclosure, the computer program instructions, when executed by the processor, cause the device to: recognize the one or more virtual objects in the virtual scene; and determine physical state information respectively corresponding to the one or more virtual objects. The physical state information includes hardness and/or roughness.

In an embodiment of the present disclosure, the computer program instructions, when executed by the processor, cause the device to: generate touch perception information respectively corresponding to the one or more virtual objects according to the physical state information of the one or more virtual objects, as the haptic feedback information. The touch perception information includes a size of a force required for perceiving hardness and/or roughness of an object.

In an embodiment of the present disclosure, the computer program instructions, when executed by the processor, cause the device to: according to a touch position of the user on a touch screen displaying an image of the virtual scene, determine a touched virtual object in the image; supply a voltage signal to the touch screen based on the touch perception information; and generate an induction capacitance and an electrostatic force at the touch position based on the voltage signal.

In an embodiment of the present disclosure, the computer program instructions, when executed by the processor, cause the device to: detect a touch pressure of the user; wherein in response to the touch pressure being greater than a preset threshold, supplying a voltage signal to the touch screen.

Additional features and advantages of the present disclosure will be set forth in the following description, and in part will be obvious from the description, or may be learned by practice of the present disclosure. The objectives and other advantages of the present disclosure may be realized and obtained by the structure particularly pointed out in the written description and claims hereof as well as the accompanying drawings.

### BRIEF DESCRIPTION OF THE DRAWINGS

To describe the technical solutions in the present disclosure more clearly, in the following accompanying drawings of the embodiments will be briefly introduced. It should be understood that the drawings described below are merely some embodiments of the present disclosure, rather than the limitations of the present disclosure, in which:

FIG. 1 is a flowchart of a method for providing haptic feedback in a virtual reality system according to an embodiment of the disclosure;

FIG. 2 is an analytical schematic diagram illustrating establishing a frequency offset and a target distance;

FIG. 3 is a contrast diagram illustrating an actual speed and a radial speed;

FIG. 4 is a schematic diagram illustrating a geometric structure for calculating a plane direction angle;

FIG. 5 is a schematic diagram illustrating geometric distribution for achieving positioning;

FIG. 6 is a schematic structural diagram of a touch screen in the related art;

FIG. 7 is a block diagram of a device for providing haptic feedback in a virtual reality system according to an embodiment of the disclosure; and

FIG. 8 is a block diagram of a device for providing haptic feedback in a virtual reality system according to another embodiment of the present disclosure.

### DETAILED DESCRIPTION

In order to make the objectives, technical solutions and advantages of the embodiments of the present disclosure more comprehensible, the technical solutions of the embodiments of the present disclosure are clearly and completely described below with reference to the accompanying drawings. Apparently, the described embodiments are only a part but not all of the embodiments of the present disclosure. All other embodiments obtained by persons of ordinary skill in the art based on the described embodiments without creative efforts shall also fall within the scope of the present disclosure.

The steps illustrated in the flowcharts of the figures may be performed in a computer system, such as a set of computer-executable instructions. Also, while the logical order is shown in the flowchart, in some cases, the steps shown or described may be performed in an order different from the order described herein.

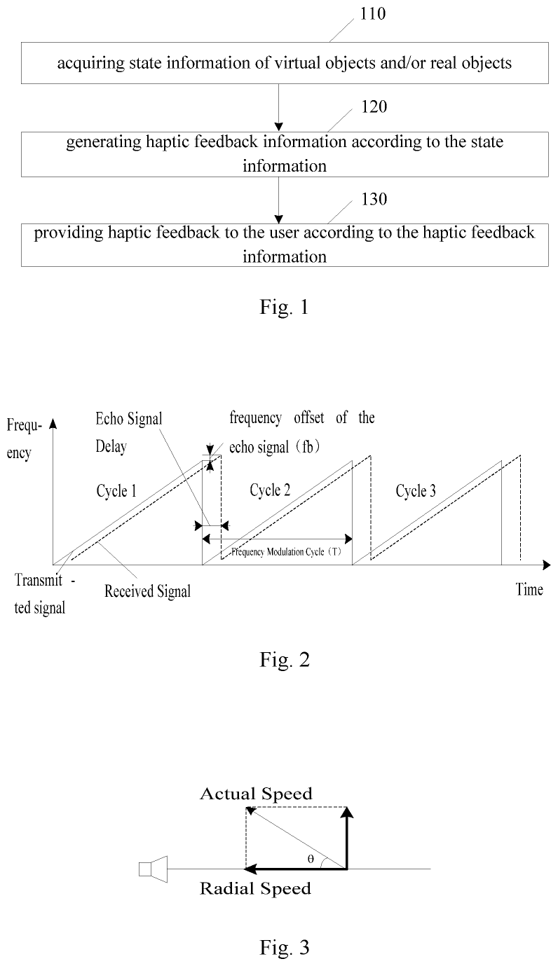

FIG. 1 is a flowchart of a method for providing haptic feedback in a virtual reality system according to an embodiment of the disclosure.

As shown in FIG. 1, at step 110, it is acquired state information of one or more virtual objects in a virtual scene presented in a virtual reality system and/or one or more real objects in an external environment of the user using the virtual reality system. At step 120, haptic feedback information is generated according to the acquired state information. At step 130, haptic feedback is provided to the user according to the generated haptic feedback information.

A process of providing haptic feedback according to movement of one or more real objects in the user's external environment will be described in detail below.

At step 110, movement state information (at least one of position, moving direction, and moving speed information) of the one or more real objects in the external environment is first detected. Specifically, it may be detected by a motion sensor such as a radar sensor or an infrared sensor, for example.

The radar sensor may include an antenna, a transceiver, a signal generation and modulation unit, a signal processing unit, and the like. The radar sensor will generate and modulate a radar signal for detecting the movement state information, and transmit the radar signal to the user's external environment through the antenna. After the radar signal meets the object and is reflected, a reflected signal is formed. The reflected signal is subject to amplification, filtering, mixing and other signal processing and calculation to detect the position, moving direction, and moving speed of the detected object. The relative speed of the object may be calculated according to the moving direction and the moving speed.

The radar signal may be a frequency modulated continuous wave, with a frequency offset between its echo signal and the transmitted signal. The frequency offset is a function of distance and may be measured by a frequency mixer. A target distance (a distance between the user and the object) may be calculated by substituting the frequency offset into the function. A first function for calculating the distance may be: fb=(2Δf·R)/(T*c), where fb denotes the frequency offset of the echo signal measured by the frequency mixer, Δf denotes the maximum frequency offset of the transmitted frequency modulated signal, T denotes the frequency modulation cycle, and R denotes the target distance. Thus, a relationship between the frequency offset and the target distance. FIG. 2 is an analytical schematic diagram illustrating establishing the relationship between the frequency offset and the target distance. The solid line indicates the transmitted signal (i.e., the transmitted signal) and the dotted line indicates the received signal (i.e., the echo signal). With reference to the relevant parameters in FIG. 2, the process of calculating the target distance may be understood.

In an embodiment of the present disclosure, the relative speed of the object may be calculated based on the Doppler principle. The measured frequency offset signal is substituted into a second function to obtain the relative speed. The second function may be expressed as: fd=2(cos θv)/λ, v denotes the relative actual speed of the object with respect to the radar, and cos θv denotes the relative radial speed of the object with respect to the radar. FIG. 3 is a contrast diagram illustrating the actual speed and radial speed. Referring to FIG. 3, the amount of frequency shift produced by the object moving toward or away from the radar is the same, with the frequency shift produced by the target moving toward the radar being positive and the frequency shift produced by the target moving away from the radar being negative.

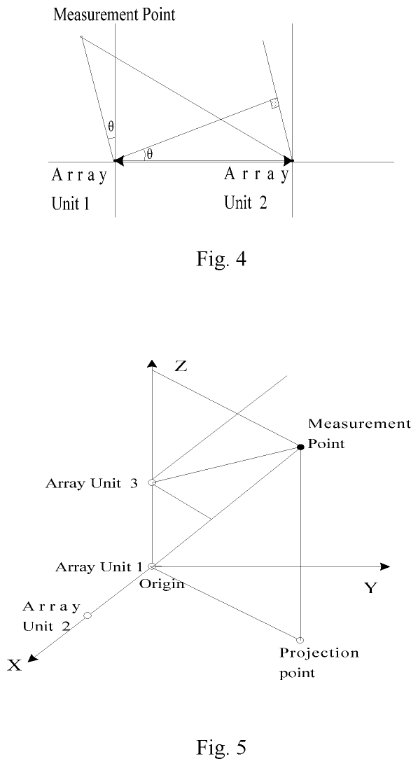

In addition, the relative angle of the object may be calculated based on the phase difference of the receiving array. First, the phase difference of the echo signal reaching the adjacent receiving array unit is measured. The phase difference is substituted into a third function to obtain a plane direction angle. The third function may be expressed as: θ=sin⁻¹(λΔφ/2πd). FIG. 4 is a schematic diagram illustrating the geometric structure for calculating the plane direction angle. As shown in FIG. 4, θ denotes the direction angle of the measurement target, Δφ denotes the phase difference, λ, denotes the wavelength, and d denotes the spacing distance between two receiving array units. The positioning may be achieved by arranging the receiving array in a reasonable manner, for example, by using three receiving array units. FIG. 5 is a schematic diagram illustrating geometric distribution for achieving the positioning. As shown in FIG. 5, an array unit 1 is the center, and an azimuth angle φ is measured according to an array unit 2 in the same row, and an elevation angle θ is measured according to an array unit 3 in the same column.

Then at step 120, a distance between the user and the one or more real objects may be determined according to the acquired movement state information of the one or more real objects. Thereby, distance-based feedback intensity information corresponding to the one or more real objects respectively is generated as the haptic feedback information.

At step 130, pressure corresponding to the feedback intensity information is provided to the user, for example using a pressure device. Vibration corresponding to the feedback intensity information is provided to the user, for example using a vibration device.

Specifically, a preset ultrasonic wave device may be used to transmit an ultrasonic wave to the user according to the generated feedback intensity information, so as to apply to the user a force corresponding to the size of the distance. For example, the ultrasound device applies a distance-based pressure to the face and/or chest of the user according to the haptic feedback information. In addition, using a preset vibration device, the vibration device is driven to vibrate according to the generated feedback intensity information, to generate a vibration corresponding to the size of the distance. When the distance between the user and the object keeps decreasing, the force of the ultrasonic transmission should be correspondingly increased. Similarly, if a haptic device is used for haptic feedback, the vibration frequency increases correspondingly, and the haptic feedback prompts the user that the object is continuously approaching. Conversely, as the distance increases, the ultrasonic wave device and/or vibration device performs the reverse process.

The embodiments of the present disclosure may provide haptic feedback according to the size of the distance between the user and the object. In other words, when using virtual reality technology, if the distance between the user and the object in the user environment changes, feedback intensity information may be set dynamically. For example, in the external environment where the user wearing the virtual reality device is located, if the user quickly approaches an object or someone approaches the user quickly, the user may clearly feel the pressure due to the decrease in distance based on the feedback intensity information. Conversely, when other person is quickly moving away from the user or the user is moving away from the object, the user may clearly feel that the pressure gradually decreases due to the increase of the distance according to the haptic feedback.

In this case, even if the user wears the virtual reality device, the user may know the movement state of the surrounding human body or object through the haptic sensing. Therefore, the user may be more relaxed into the virtual reality scene without worrying about colliding with the human body or the object in the environment where the user is located, so as to obtain an improved user experience.

In addition, the size of the pressure may be set to be related to the speed of the object. For example, the pressure may be set to change quickly as the speed changes quickly, and the pressure may be set to change slowly as the speed changes slowly.

A process of providing haptic feedback for physical states of one or more virtual objects in a virtual scene will be described in detail below.

At step 110, one or more virtual objects in the virtual scene are identified and physical state information respectively corresponding to the one or more virtual objects is determined. The physical state information is, for example, the hardness, the roughness of the object felt by the user when touching the real object.

Specifically, an image in the virtual scene may be acquired by using an image acquisition device. After the feature points are extracted from the acquired image, the extracted feature points are matched with feature points for image matching that are stored in advance in a database, to determine the virtual objects contained in the virtual scene. In addition, the object in the virtual scene may be recognized by a preset identifier. The identifier of the object displayed in the display screen may be acquired, and the displayed object may be determined according to the acquired identifier. The image matching method may perform an image matching process based on an existing feature database, which require a certain calculation. The method for recognizing an object with an identifier requires setting identifier for each object according to a one-to-one correspondence in advance, but the method does not require matching calculation.

Next, at step 120, touch perception information respectively corresponding to the one or more virtual objects may be generated according to the physical state information of the one or more virtual objects, as the haptic feedback information, for example, a size of a force required for perceiving the hardness and/or roughness of the object.

At step 130, an image corresponding to the image in the virtual scene is displayed on the touch screen, and the touched virtual object in the image is determined according to the touch position of the user on the touch screen. Based on the generated touch perception information, a voltage signal is supplied to the touch screen. Also, an induction capacitance and an electrostatic force are generated at the touch position of the touch screen based on the supplied voltage signal.

Thereby, when the user views the virtual reality image and touches the touch screen, the electrostatic force generated based on the touch perception information may be obtained, so as to obtain the haptic sensation of the hardness and/or the roughness of the object displayed on the touched position. Therefore, the user may get a more intuitive experience, thereby enhancing the user experience of the virtual reality technology.

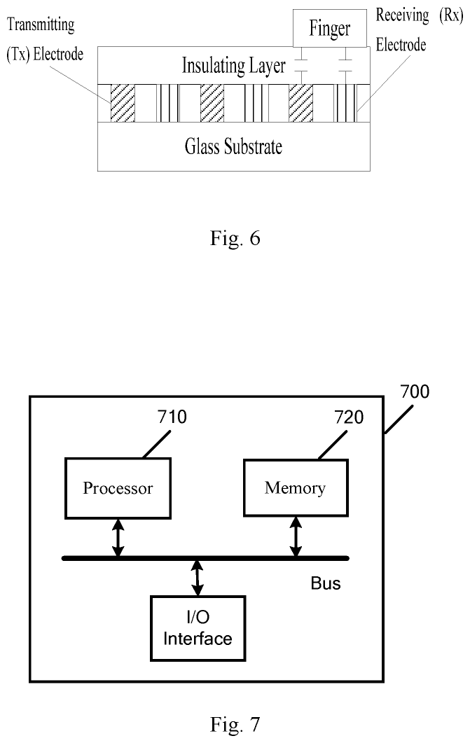

FIG. 6 is a schematic structural diagram of a touch screen in the related art. As shown in FIG. 6, the touch screen includes a glass substrate, a transmitting (Tx) electrode and a receiving (Rx) electrode disposed on the glass substrate and an insulating layer. The Tx electrode may receive a first voltage signal, and the Rx may receive a second voltage signal. When the user touches the touch screen with a finger, the touched object may be determined according to the touch position of the user, and based on the attribute information of the touched object, the first voltage signal and the second voltage signal may be generated to be provided to the Tx electrode and the Rx electrode at the touch position. Therefore, an induction capacitance may be generated between the finger and the overlapping region of the Tx electrode and the Rx electrode, and an electrostatic force acting on the finger may be generated to allow the user to obtain haptic sensation of the touched object. Therefore, when the user's finger touches the touch screen, the finger may obtain the action of the electrostatic force so that haptic sensation may be obtained. In addition, when the user's finger slides, the electrostatic force may change due to the area of the overlapping area of the finger and the Tx electrode and the Rx electrode is changed.

In this embodiment, different first voltage signals and second voltage signals may be provided for different touched objects. Since different voltage signals may match different sizes of electrostatic forces, and different sizes of electrostatic forces correspond to different haptic sensations, the user may feel like touching different objects (such as cashmere, linen, rock, etc.). In an embodiment of the present disclosure, the attribute information of various objects and the corresponding voltage signal may be stored in the storage unit in advance, so that the voltage signal corresponding to the attribute information of the touched object may be acquired from the storage unit.

Further, it is also possible to detect the user's touch pressure before providing the user with haptic feedback. In response to the touch pressure being greater than a preset threshold, a voltage signal is supplied to the touch screen. Therefore, it may be determined that the user touches the object in the virtual scene when the pressure on the touch screen is greater than the preset threshold. Then the user may acquire the haptic feedback at a more accurate time and have a better experience.

As an optional embodiment, a virtual button in the embodiment of the present disclosure may generate a texture pattern corresponding to the content represented by the virtual button, based on the method for generating haptic perception information according to the embodiment of the present disclosure. For example, a button with touchable direction icons may be generated according to the idea of haptic feedback based on haptic perception information on a display screen.

The method for providing haptic feedback in a virtual reality system according to the embodiment of the present disclosure enables haptic feedback according to the state information of the object. When the user applies the virtual reality technology, the user may know the movement state of the human body or the object in the environment where the user is using the virtual reality technology, so that the user may be further immerged in the virtual scene according to the haptic feedback. On the other hand, in the virtual scene, the experience of using the virtual reality technology may be improved according to the haptic feedback. The embodiment of the present disclosure can realize haptic feedback during virtual reality interaction and improve the user experience of virtual reality.

FIG. 7 is a block diagram of a device 700 for providing haptic feedback in a virtual reality system according to an embodiment of the disclosure. As shown in FIG. 7, the device 700 includes one or more processors 710 and a memory 720. The memory 720 is coupled to the processor 710 through a bus and an I/O interface and stores computer program instructions. The computer program instructions, when executed by the processor 710, cause the device 700 to perform: acquiring state information of one or more virtual objects in a virtual scene presented in a virtual reality system and/or one or more real objects in an external environment of the user using the virtual reality system; generating haptic feedback information according to the state information; and providing haptic feedback to the user according to the generated haptic feedback information.

For real objects in the user's external environment, the device 700 may detect movement state information (such as position, moving direction, moving speed, and the like) of one or more real objects in the external environment through a motion sensor such as a radar sensor or the like. The device 700 may determine the distance between the user and one or more real objects according to the movement state information of the one or more real objects. The device 700 generates distance-based feedback intensity information respectively corresponding to the one or more real objects, as the haptic feedback information. In addition, the device 700 may provide the user with the pressure corresponding to the feedback intensity information through a pressure device, and/or provide the user with vibration corresponding to the feedback intensity information through a vibration device.

For a virtual object in a virtual scene, the device 700 may recognize one or more virtual objects in the virtual scene, determine physical state information corresponding to the one or more virtual objects respectively, such as hardness, roughness, and the like. The device 700 may further generate touch perception information corresponding to the virtual object as the haptic feedback information according to the physical state information of the virtual object. The touch perception information includes, for example, a size of a force required for perceiving the hardness and/or roughness of the object. The device 700 may determine the touched virtual object in the image according to the touch position of the user on the touch screen displaying the image of the virtual scene and provide to the touch screen a voltage signal based on the touch perception information of the touched virtual object and further based on the voltage signal, generate an induction capacitance and an electrostatic force on the touch screen. Further, the device 700 may also detect the user's touch pressure. In response to the touch pressure being greater than a preset threshold, the device 700 may supply a voltage signal to the touch screen.

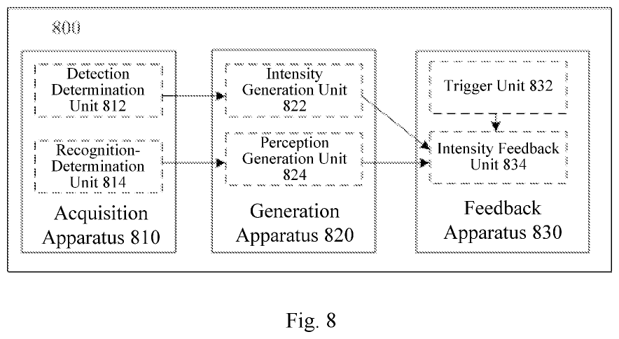

FIG. 8 a block diagram of a device 800 for providing haptic feedback in a virtual reality system according to another embodiment of the present disclosure. As shown in FIG. 8, the device 800 includes an acquisition apparatus 810, a generation apparatus 820, and a feedback apparatus 830. The acquisition apparatus 810 may acquire state information of one or more virtual objects in a virtual scene presented in the virtual reality system and/or one or more real objects in an external environment of a user using the virtual reality system. The generation apparatus 820 may generate haptic feedback information according to the state information. The feedback apparatus 830 may provide haptic feedback to the user according to the haptic feedback information.

In an embodiment of the present disclosure, the acquisition apparatus 810 includes a detection determination unit 812 and/or a recognition-determination unit 814. The detection determination unit 812 may detect movement state information of the one or more real objects in the external environment, such as position, moving direction, and moving speed, and the like. The recognition-determination unit 814 may recognize the one or more virtual objects in the virtual scene, and determine physical state information respectively corresponding to the one or more virtual objects, such as hardness and/or roughness.

The generation apparatus 820 includes an intensity generation unit 822 and/or a perception generation unit 824. The intensity generation unit 822 may determine a distance between the user and the one or more real objects according to the movement state information of the one or more real objects, and generate distance-based feedback intensity information corresponding to the one or more real objects respectively as the haptic feedback information. The perception generation unit 824 may generate touch perception information respectively corresponding to the one or more virtual objects according to the physical state information of the one or more virtual objects, as the haptic feedback information. The touch perception information includes a size of a force required for perceiving hardness and/or roughness of an object, and the like.

The feedback apparatus 830 includes an intensity feedback unit 834. The intensity feedback unit 834 may provide pressure corresponding to the feedback intensity information to the user; and/or provide vibration corresponding to the feedback intensity information to the user. On the other hand, the intensity feedback unit 834 may also, according to a touch position of the user on a touch screen displaying an image of the virtual scene, determine a touched virtual object in the image, supply a voltage signal to the touch screen based on the touch perception information of the touched virtual object, and generate an induction capacitance and an electrostatic force at the touch screen based on the voltage signal. In addition, the feedback apparatus 830 may further include a trigger unit 832, to detect a touch pressure of the user. In response to the touch pressure being greater than a preset threshold, the feedback unit 832 may supply a voltage signal to the touch screen.

A person of ordinary skill in the art may understand that all or part of the steps in the foregoing methods may be implemented by a program instructing relevant hardware (for example, a processor), and the program may be stored in a computer-readable storage medium, such as a read-only memory, a magnetic disk, and the like. Optionally, all or part of the steps of the above embodiments may also be implemented by using one or more integrated circuits. Correspondingly, each module/unit/device in the above embodiments may be implemented in the form of hardware, for example, by an integrated circuit to realize its corresponding function, or may be implemented in the form of software function module, for example, by a processor to execute programs/instructions stored in a memory to realize its corresponding function. This disclosure is not limited to any particular form of combination of hardware and software.

Although the disclosed embodiments of the present disclosure are as described above, the content described above is only used to facilitate understanding of the embodiments of the present disclosure, and is not intended to limit the disclosure. Those skilled in the art to which the present disclosure pertains may make any alterations and modifications in the form and details of implementation without departing from the spirit and scope of the present disclosure. However, the scope of the patent protection of the present disclosure is defined by the appended claims.

1. A method for providing haptic feedback in a virtual reality system, comprising:
acquiring state information of one or more virtual objects in a virtual scene presented in the virtual reality system and/or one or more real objects in an external environment of a user using the virtual reality system;
generating haptic feedback information according to the state information; and
providing haptic feedback to the user according to the haptic feedback information.

2. The method according to claim 1, wherein the step of acquiring state information of one or more real objects in an external environment of a user using the virtual reality system, comprises:
detecting movement state information of the one or more real objects in the external environment;
wherein the movement state information comprises at least one of position, moving direction, and moving speed.

3. The method according to claim 2, wherein the step of generating haptic feedback information according to the state information comprises:
determining a distance between the user and the one or more real objects according to the movement state information of the one or more real objects; and
generating distance-based feedback intensity information corresponding to the one or more real objects respectively as the haptic feedback information.

4. The method according to claim 3, wherein the step of providing haptic feedback to the user according to the haptic feedback information comprises:
providing pressure corresponding to the feedback intensity information to the user; and/or
providing vibration corresponding to the feedback intensity information to the user.

5. The method according to claim 1, wherein the step of acquiring state information of one or more virtual objects in a virtual scene presented in the virtual reality system comprises:
recognizing the one or more virtual objects in the virtual scene; and
determining physical state information respectively corresponding to the one or more virtual objects;
wherein the physical state information comprises hardness and/or roughness.

6. The method according to claim 5, wherein the step of generating haptic feedback information according to the state information comprises:
generating touch perception information respectively corresponding to the one or more virtual objects according to the physical state information of the one or more virtual objects, as the haptic feedback information;
wherein the touch perception information comprises a size of a force required for perceiving hardness and/or roughness of an object.

7. The method according to claim 6, wherein the step of providing haptic feedback to the user according to the haptic feedback information comprises:
according to a touch position of the user on a touch screen displaying an image of the virtual scene, determining a touched virtual object in the image;
supplying a voltage signal to the touch screen based on the touch perception information of the touched virtual object; and
generating an induction capacitance and an electrostatic force at the touch position based on the voltage signal.

8. The method according to claim 7, wherein the step of providing haptic feedback to the user according to the haptic feedback information further comprises:
detecting a touch pressure of the user,
wherein in response to the touch pressure being greater than a preset threshold, a voltage signal is supplied to the touch screen.

9. A device for providing haptic feedback in a virtual reality system, comprising:
one or more processors;
a memory coupled to the processor and storing computer program instructions,
wherein the computer program instructions are configured to control the device to:
acquire state information of one or more virtual objects in a virtual scene presented in the virtual reality system and/or one or more real objects in an external environment of a user using the virtual reality system;
generate haptic feedback information according to the state information; and
provide haptic feedback to the user according to the haptic feedback information.

10. The device according to claim 9, wherein the computer program instructions are configured to control the device to:
detect movement state information of the one or more real objects in the external environment;
wherein the movement state information comprises at least one of position, moving direction, and moving speed.

11. The device according to claim 10, wherein the computer program instructions are configured to control the device to:
determine a distance between the user and the one or more real objects according to the movement state information of the one or more real objects; and
generate distance-based feedback intensity information corresponding to the one or more real objects respectively as the haptic feedback information.

12. The device according to claim 11, wherein the computer program instructions are configured to control the device to:
provide pressure corresponding to the feedback intensity information to the user; and/or
provide vibration corresponding to the feedback intensity information to the user.

13. The device according to claim 9, wherein the computer program instructions are configured to control the device to:
recognize the one or more virtual objects in the virtual scene; and
determine physical state information respectively corresponding to the one or more virtual objects;
wherein the physical state information comprises hardness and/or roughness.

14. The device according to claim 13, wherein the computer program instructions are configured to control the device to:
generate touch perception information respectively corresponding to the one or more virtual objects according to the physical state information of the one or more virtual objects, as the haptic feedback information;
wherein the touch perception information comprises a size of a force required for perceiving hardness and/or roughness of an object.

15. The device according to claim 14, wherein the computer program instructions are configured to control the device to:
according to a touch position of the user on a touch screen displaying an image of the virtual scene, determine a touched virtual object in the image;
supply a voltage signal to the touch screen based on the touch perception information of the touched virtual object; and
generate an induction capacitance and an electrostatic force at the touch position based on the voltage signal.

16. The device according to claim 15, wherein the computer program instructions are configured to control the device to:
detect a touch pressure of the user;
wherein in response to the touch pressure being greater than a preset threshold, supplying a voltage signal to the touch screen.

17. The method according to claim 2, wherein the step of acquiring state information of one or more virtual objects in a virtual scene presented in the virtual reality system comprises:
recognizing the one or more virtual objects in the virtual scene; and
determining physical state information respectively corresponding to the one or more virtual objects;
wherein the physical state information comprises hardness and/or roughness.

18. The method according to claim 3, wherein the step of acquiring state information of one or more virtual objects in a virtual scene presented in the virtual reality system comprises:
recognizing the one or more virtual objects in the virtual scene; and
determining physical state information respectively corresponding to the one or more virtual objects;
wherein the physical state information comprises hardness and/or roughness.

19. The method according to claim 4, wherein the step of acquiring state information of one or more virtual objects in a virtual scene presented in the virtual reality system comprises:
recognizing the one or more virtual objects in the virtual scene; and
determining physical state information respectively corresponding to the one or more virtual objects;
wherein the physical state information comprises hardness and/or roughness.

20. The device according to claim 10, wherein the computer program instructions are configured to control the device to:
recognize the one or more virtual objects in the virtual scene; and
determine physical state information respectively corresponding to the one or more virtual objects;
wherein the physical state information comprises hardness and/or roughness.
